(19) United States
(12) Patent Application Publication
(10) Pub. No.: US 2009/0096747 A1
(43) Pub. Date: Apr. 16, 2009

(54) Method of rolling picture using input device

(75) Inventor: Chin-Wen Chou, Taipe Hsien (TW)

Correspondence Address: Joe McKinney Muncy, PO Box 1364, Fairfax, VA, 22038-1364, US

(73) Assignee: Zippy Technology Corp.

(21) Appl. No.: 11/907,277

(22) Filed: Oct. 10, 2007

(51) Int. Cl. G09G 5/00

(52) U.S. Cl. 345/156

(57) ABSTRACT

A method of rolling picture by using input device is disclosed. The input device has a housing and a rotatable component relative to the housing, and through rotating the component, an instruction signal for rolling picture being produced. The method includes steps of setting picture rolling, wherein the input device is set to have at least a first mode or a second mode for rolling the picture, in which each mode is set to have a picture rolling displacement which is corresponding to the driven picture rolling by the single instruction signal every time, and different modes have different displacements; and deciding the mode, wherein a standard value which is compared with the number of instruction signal generated per unit time for deciding the mode of the instruction signal is provided, and through the standard value, the instruction signal is decided to enter the first mode or the second mode.

### FIELD OF THE INVENTION

The present invention is related to a method of rolling picture by using an input device, and more particularly to a method of rolling picture by using an input device which can achieve an automatic variation of picture rolling distance according to the number of instruction signal generated per unit time.

### BACKGROUND OF THE INVENTION

The conventional computer input device utilizes wheel's rolling to move the image displayed on the screen to have a fast scrolling along the longitudinal direction. One of the common wheel modules is R.O.C Patent No. M261764 which discloses an indicator input device with paging function, wherein the photoelectric receiver is used to sense that if the light signal outputted by the photoelectric transmitter is masked by the grating owing to the rolling of the wheel, so as to provide the computer the basis for controlling the paging movement of the picture on the screen, and with the software, the rolling distance can be controlled, as shown in FIG. 1. Since, nowadays, the data content is increased significantly and one single document might even include hundreds of pages, according to the available technology, the user can control the software to adjust the rolling distance for matching to different data contents. For example, the rolling distance should be adjusted as three rows per grid as the document contains one single page, and as one page per grid as the document contains hundreds of pages. However, for achieving this, the user has to change the setting every time open another document, which is really inconvenient.

Therefore, a computer input device capable of rapidly rolling the picture is developed, e.g., VX Revolution produced by Logitech (http://www.logitech.com/index.cfm/mice_po'inters/mice/devices/165), and MX Revolution (http://www.logitech.com/index.cfm/mice_pointers/mice/devices/130), which utilizes a ultra-precise gear (MicroGear) for significantly improving the picture rolling speed. In the gear described above, a ratchet-scrolling mechanism is added on the exterior of the wheel. In a normal mode, the ratchet-scrolling mechanism grips the hinge of the wheel, so that the wheel can roll slowly, the user can feel the rise-and-fall touch and the picture on the screen also can have a slow rolling. Then, when the ratchet-scrolling mechanism retracts and releases the hinge, the wheel can have a hyper-fast spin, the user can feel the nearly frictionless long-distance rolling, and of course, the picture on the screen also can roll rapidly. That is, the rolling distance is controlled by the ratchet-scrolling mechanism without additional setting according to the page number.

However, according to the above, it needs to additionally install the ratchet-scrolling mechanism into the input device, whose inner space is already full and is hard to spare extra space for accommodating the ratchet-scrolling mechanism, and further, the manufacturing cost and time also have to be increased. Therefore, how to solve the problem described above has become a major target for the industries.

### SUMMARY OF THE INVENTION

The object of the present invention is to utilize the original frame of the input device to achieve an automatic variation of picture rolling distance according to the number of instruction signal generated per unit time.

For achieving the object described above, the present invention provides a method of rolling picture by using an input device, which has a housing and a rotatable component relative to the housing, and through rotating the component, an instruction signal for rolling picture being produced. The method includes steps of setting picture rolling, wherein the input device is set to have at least a first mode or a second mode for rolling the picture, in which each mode is set to have a picture rolling displacement which is corresponding to the driven picture rolling by the single instruction signal every time, and different modes have different displacements, and deciding the mode, wherein a standard value which is compared with the number of instruction signal generated per unit time for deciding the mode of the instruction signal is provided, and through the standard value, the instruction signal is decided to enter the first mode or the second mode.

### BRIEF DESCRIPTION OF THE DRAWINGS

The foregoing aspects and many of the attendant advantages of this invention will be more readily appreciated as the same becomes better understood by reference to the following detailed description, when taken in conjunction with the accompanying drawings, wherein:

FIG. 1 is a schematic view showing the setting of rolling distance in the prior art;

FIG. 2 is a three-dimensional appearance view showing an input device in a preferred embodiment according to the present invention;

FIG. 3 is a decomposition drawing showing an input device in a preferred embodiment according to the present invention;

FIG. 4 is a schematic view showing the original static state of the input device in a preferred embodiment according to the present invention;

FIG. 5 is a schematic view showing the rolling of the input device in a preferred embodiment according to the present invention;

FIG. 6 is a flow chart showing in a preferred embodiment according to the present invention;

FIG. 7A is a schematic view showing the setting of the rolling distance in a preferred embodiment according to the present invention;

FIG. 7B is schematic view showing the setting of the rolling distance in another preferred embodiment according to the present invention;

FIG. 8A is a schematic view showing the rolling a first mode in a preferred embodiment according to the present invention;

FIG. 8B is another schematic view showing the rolling a first mode in a preferred embodiment according to the present invention;

FIG. 9A is a schematic view showing the rolling a second mode in a preferred embodiment according to the present invention;

FIG. 9B is another schematic view showing the rolling a second mode in a preferred embodiment according to the present invention;

FIG. 10 is a graph showing the rolling modes in a preferred embodiment according to the present invention;

FIG. 11 is a graph showing the rolling modes in another preferred embodiment according to the present invention; and

FIG. 12 is a graph showing the rolling modes in further another preferred embodiment according to the present invention.

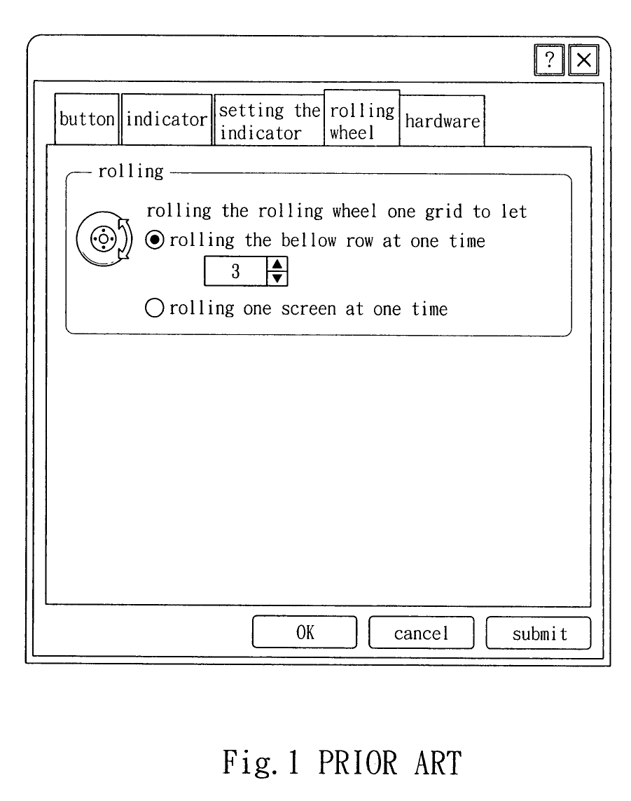

### DESCRIPTION OF THE PREFERRED EMBODIMENT

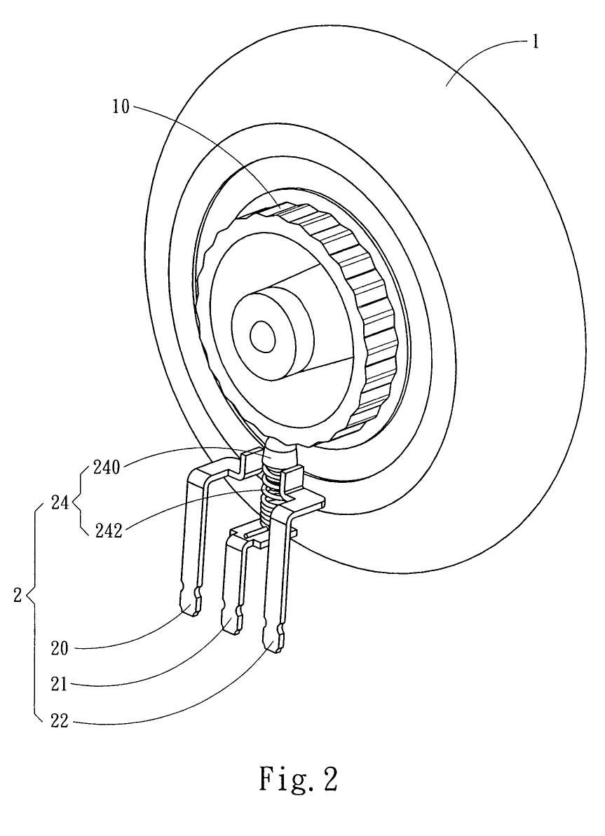

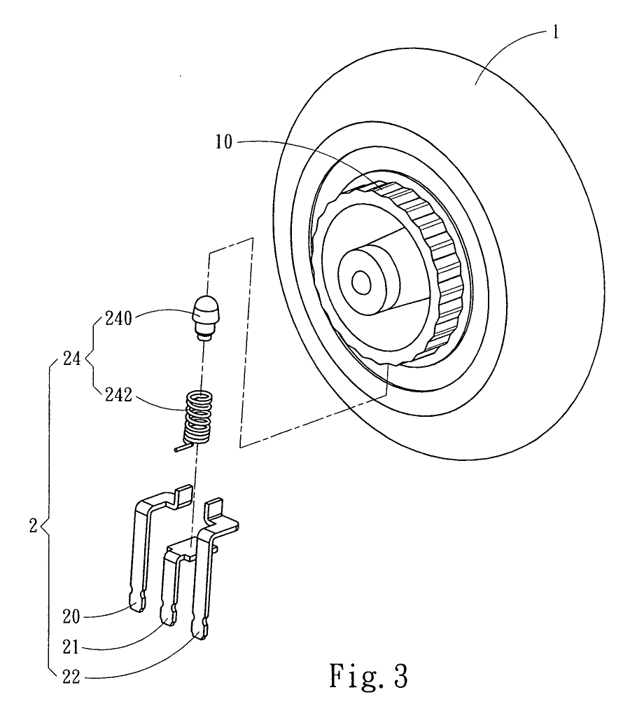

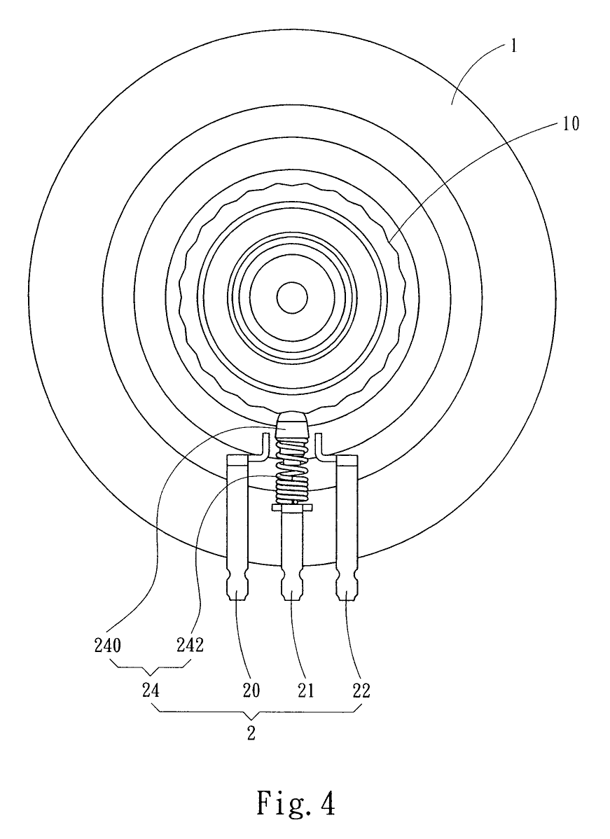

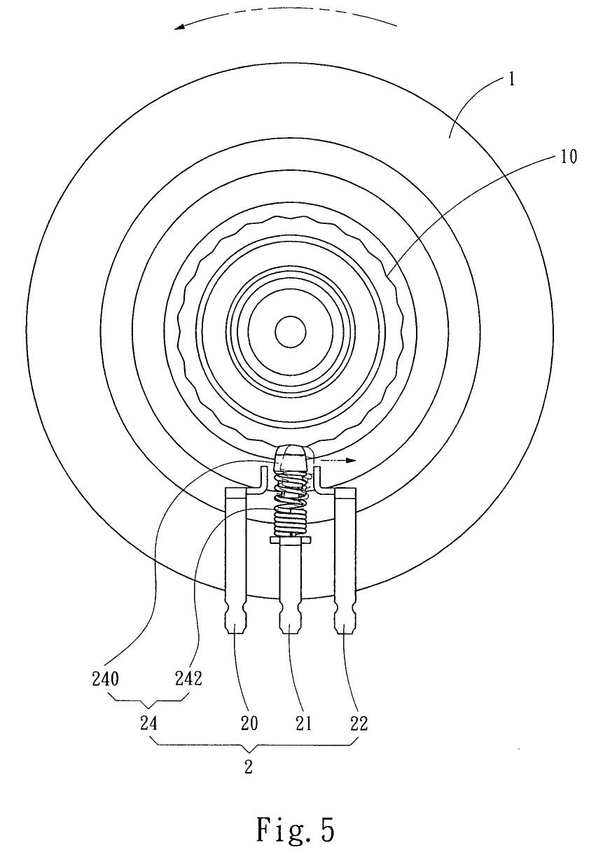

The present invention provides a method for rolling the picture by using an input device. In the embodiment, an input device (as shown in FIG. 2 and FIG. 3) is adopted but not limited. The input device includes a housing (not shown in the figures) and a rotatable component relative to the housing, and through rotating the component, an instruction signal for rolling picture can be produced. The component includes a wheel 1 and a signal production mechanism 2 cooperated with the wheel 1, wherein the signal production mechanism 2 has a common pin 21, and a forward pin 20 and a backward pin 22 which are respectively located at the two sides of the common pin 21, and the common pin 21 is connected to an electric conducting element 24. The electric conducting element 24 includes a metal bolt 240 and an elastic element 242 connected to one end of the metal bolt 240. The wheel 1 has a rolling surface 10 with raised and fallen portions spaced at intervals. Then, please refer to FIG. 4 and FIG. 5, when the wheel 1 executes a forward stroke, the raised portion on the rolling surface 10 will reject and move the common pin 21 to contact the forward pin 20, so as to produce a forward instruction, and when the wheel 1 executes a backward stroke, the raised portion on the rolling surface 10 will reject and move the common pin 21 to contact the backward pin 22, so as to produce a backward instruction.

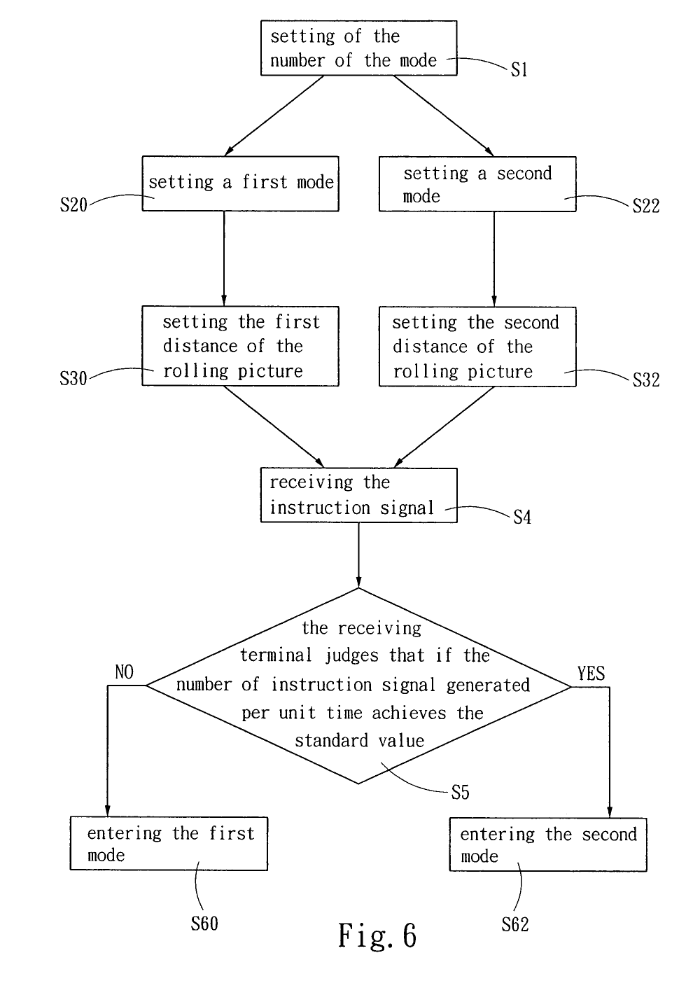

Further, please refer to FIG. 6, which is a flow chart showing a preferred embodiment according to the present invention. The method for rolling picture by using an input device includes steps as followed.

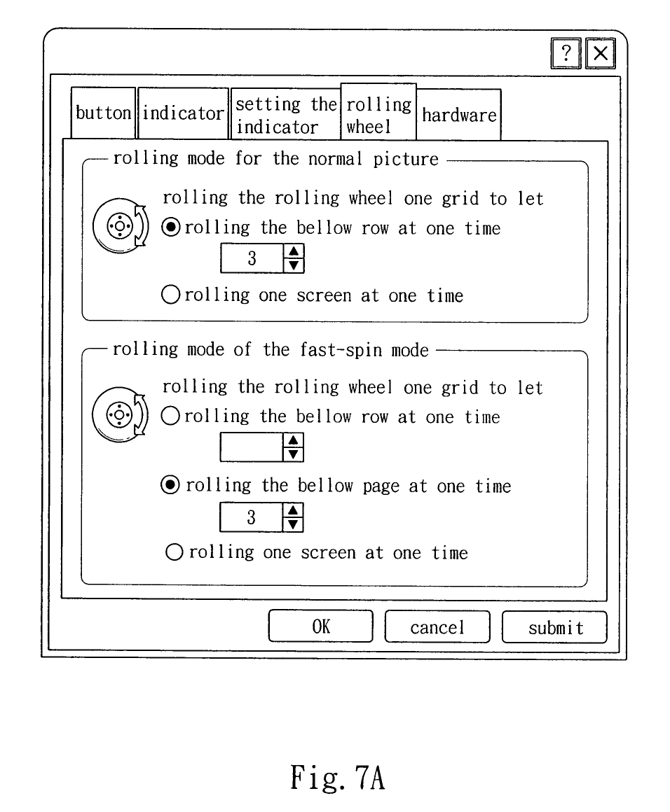

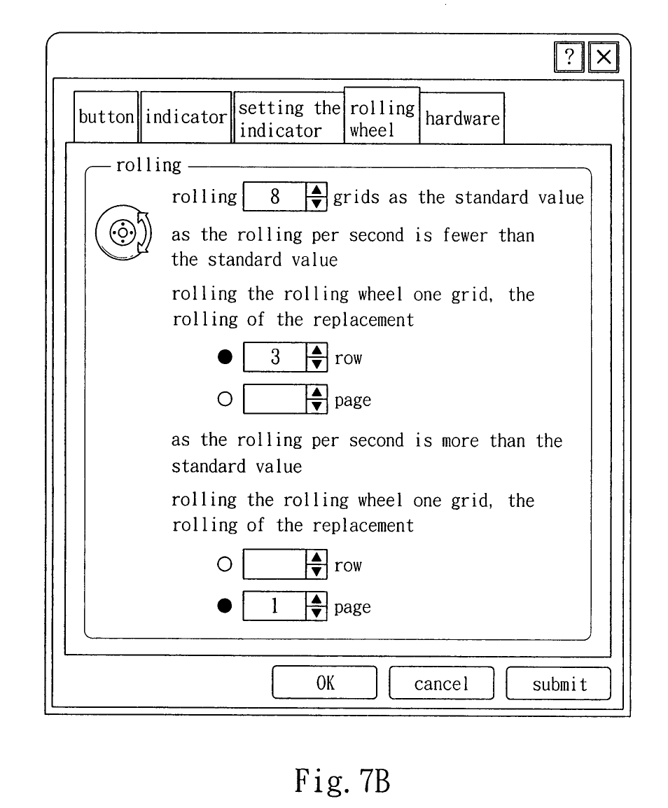

First is a picture rolling setting step. Through the driver of the input device providing the user the setting of the number of the mode (S1), the input device can enter the first mode or the second mode for rolling the picture. Here, a standard value is provided so that after the number of instruction signal produced per unit time is compared with the standard value, the input device can recognize that the instruction signal belongs to the first or second mode. Moreover, the steps for setting picture rolling are setting the rolling displacement for each mode (S20, S22) and setting the rolling displacement of the picture in each mode corresponding to the driven picture rolling by the single instruction signal every time (namely the first and the second distances shown in FIG. 6) (S30, S32), wherein different modes should have different displacements. As shown in FIG. 7A, the first mode represents the normal rolling mode and the second mode represents the fast-spin mode, the user can select the picture rolling displacement through the menu, and the standard value is automatically set by the driver. Alternatively, as shown in FIG. 7B, the standard value also can be set manually through the menu, for example, can be set as eight, so that when the rolling per second is fewer than or identical to eight grids, the first mode which rolls three rows per time is executed, and oppositely, when the rolling per second is larger than 8 grids, the second mode which rolls one page per time is executed.

Second is a mode decision step. According to the force of the user for rolling the wheel 1, no matter in the forward or the backward stroke, every time the metal bolt 240 contacts the forward pin 20 or the backward pin 22, one instruction signal is generated and then transmitted to a receiving terminal (e.g., the computer) for receiving instruction signal (S4). Then, the receiving terminal judges that if the number of instruction signal generated per unit time achieves the standard value, eight grids per second (S5).

Furthermore, the method also includes a step of locking the instruction signal on the first mode or the second mode after the deciding step (not shown in the figures).

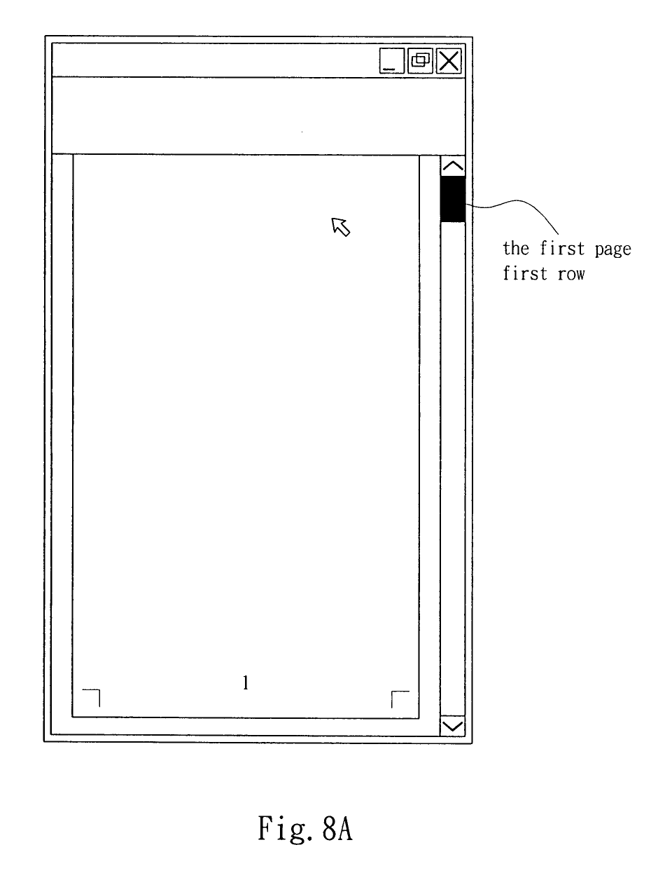

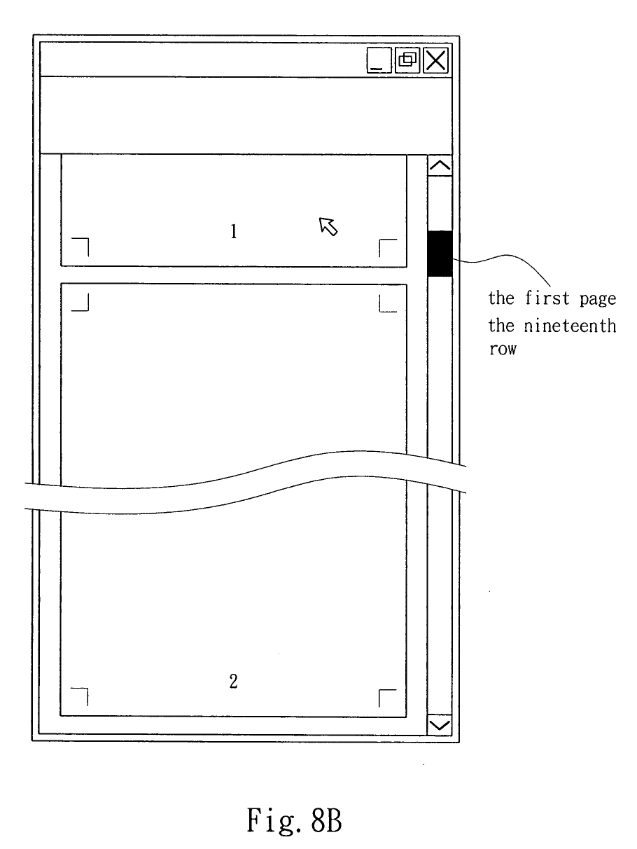

For example, when the instruction signal is generated six times per second, the first mode is selected since the standard value of eight is not achieved, so that the picture is rolled according to the first mode's settings (S60), wherein in the six instruction signals, each will trigger a first mode three rows rolling, so that the displacement between the original position in FIG. 8A and the position after rolling in FIG. 8B is eighteen rows.

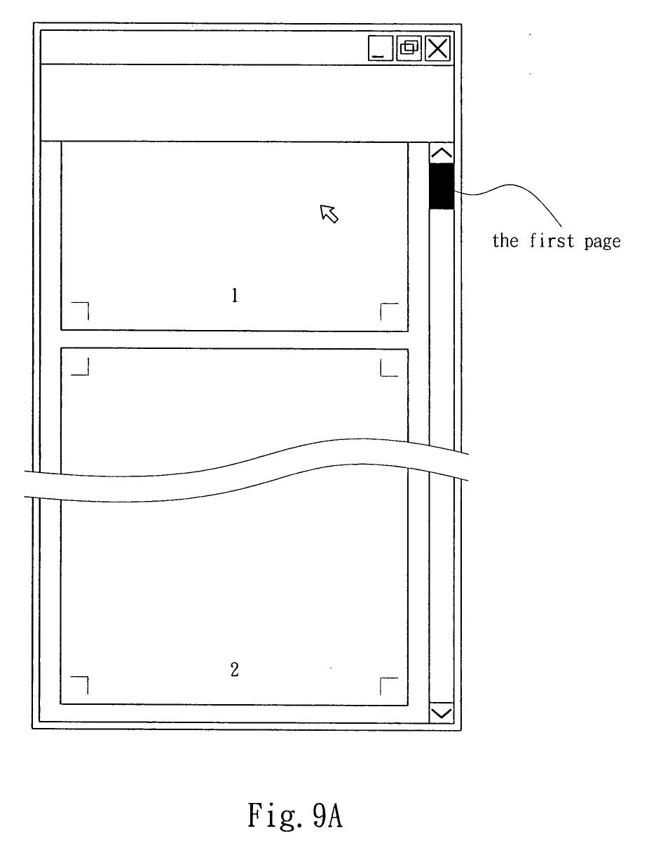

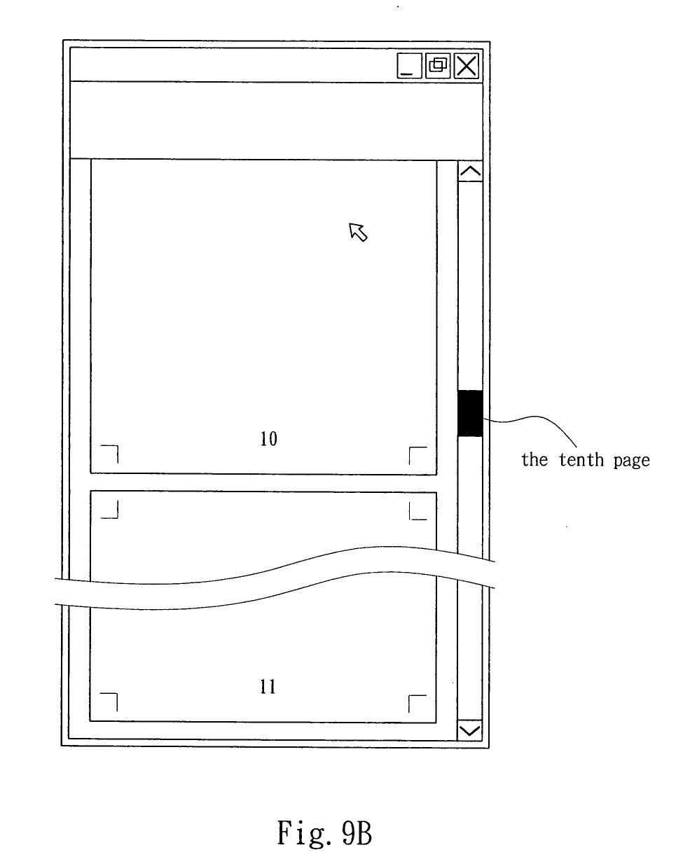

When the instruction signal is generated nine times per second, the second mode is selected since the standard value of eight is achieved, so that the picture is rolled according to the second mode's settings (S62), wherein in the nine instruction signals, each will trigger a second mode one page rolling, so that the displacement between the original position in FIG. 9A and the position after rolling in FIG. 9B is nine pages.

The decision of the instruction signal for executing the first or the second mode can be as follows:

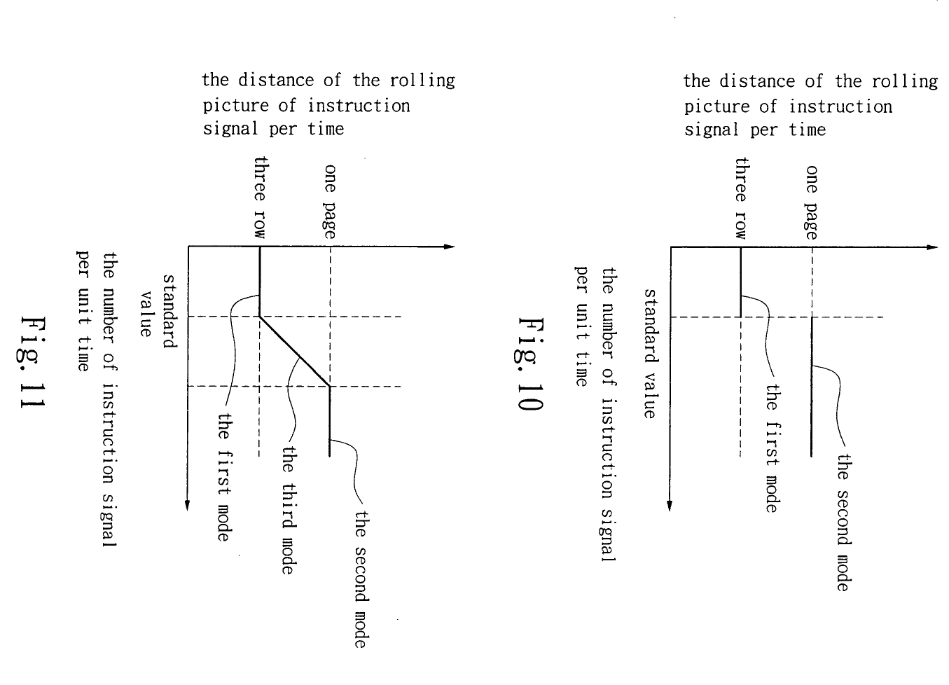

FIG. 10 shows that when the number of instruction signal generated per unit time is fewer than the standard value, the instruction signal executes the first mode rolling, and if the number of instruction signal generated per unit time is larger than the standard value, the instruction signal executes the second mode rolling;

FIG. 11 shows that in the picture rolling setting step, a third mode between the first and the second mode is included, and the displacement of the third mode is set to have a slope linear modulation between the first and the second mode; and

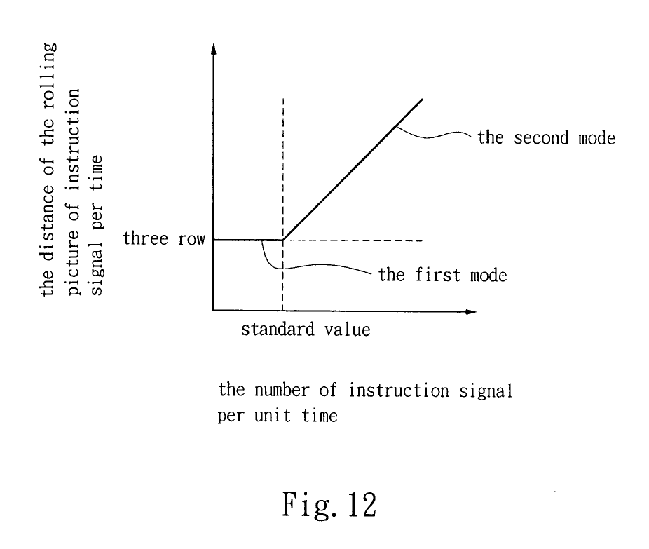

FIG. 12 shows that when the number of instruction signal generated per unit time is fewer than the standard value, the instruction signal executes the first mode rolling, and if the number of instruction signal per unit time is larger than the standard value, the instruction signal executes the second mode rolling, wherein the second mode has a slope linear modulation.

In the aforesaid, the present invention can utilize the original frame of the input device to achieve an automatic variation of picture rolling distance according to the number of instruction signal per unit time in different documents having different pages with or without the mode setting, so that not only the inconvenience that the rolling distance has to be varied in documents containing different pages can be avoided, but the increment of manufacturing cost and time caused by additionally installing mechanism also can be prevented.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A method of rolling picture by using an input device, the input device having a housing and a rotatable component relative to the housing and through rotating the component, an instruction signal for rolling picture being produced, the method comprising steps of:
setting picture rolling, wherein the input device is set to have at least a first mode or a second mode for rolling the picture, and each mode is set to have a picture rolling displacement which is corresponding to the driven picture rolling by the single instruction signal every time, and different modes have different displacements; and
deciding the mode, wherein a standard value which is compared with the number of instruction signal generated per unit time for deciding the mode of the instruction signal is provided, and through the standard value, the instruction signal is decided to enter the first mode or the second mode.

2. The method as claimed in claim 1, further comprising the step of locking the instruction signal on the first mode or the second mode after the deciding step.

3. The method as claimed in claim 1, further comprising the step of setting displacement before the setting step of picture rolling.

4. The method as claimed in claim 1, wherein the displacement of the first mode is a selected row number in the picture.

5. The method as claimed in claim 1, wherein the displacement of the second mode is a selected page number in the picture.

6. The method as claimed in claim 1, wherein when the number of instruction signal generated per unit time is fewer than the standard value, the instruction signal executes the first mode rolling, and if the number of instruction signal generated per unit time is larger than the standard value, the instruction signal executes the second mode rolling.

7. The method as claimed in claim 1, wherein in the setting step of picture rolling, a third mode between the first and the second mode is further included, and the displacement of the third mode is set to have a slope linear modulation between the first and the second mode.

8. The method as claimed in claim 1, wherein when the number of instruction signal generated per unit time is fewer than the standard value, the instruction signal executes the first mode rolling, and if the number of instruction signal per unit time is larger than the standard value, the instruction signal executes the second mode rolling, wherein the second mode has a slope linear modulation.
